(19) United States
(12) Patent Application Publication
(10) Pub. No.: US 2025/0170612 A1
(43) Pub. Date: May 29, 2025

(54) MULTI-RESONANCE FLEXTENSIONAL LOW FREQUENCY ACOUSTIC PROJECTOR

(71) Applicant: AGENCY FOR DEFENSE DEVELOPMENT, Daejeon (KR)

(72) Inventors: Yub JE, Daejeon (KR); Soon-Hyun Lim, Daejeon (KR); Yo-Han Cho, Daejeon (KR); Hee-Seon Seo, Daejeon (KR); Sang-Goo Lee, Incheon (KR)

(21) Appl. No.: 18/915,278

(22) Filed: Oct. 14, 2024

(30) Foreign Application Priority Data
Nov. 27, 2023 (KR) 10-2023-0166507

(51) Int. Cl. B06B 1/02; B06B 1/06

(52) U.S. Cl. CPC B06B 1/0269; B06B 1/0614; B06B 2201/40; B06B 2201/74

(57) ABSTRACT

A multi-resonance flextensional low frequency acoustic projector of the present disclosure includes a piezoelectric actuator; a plurality of staves attached to an outer surface of the piezoelectric actuator to convert longitudinal vibration generated by the piezoelectric actuator into lateral vibration perpendicular to the outer surface of the piezoelectric actuator; and an acoustic window surrounding an exterior of the staves and water-tightening the inside of the projector. The plurality of staves is configured in shapes different from each other to generate two or more types of resonance vibration modes, so there is an effect of allowing low frequency acoustic transmission in a wide frequency band.

### CROSS REFERENCE TO RELATED APPLICATION

The present application claims priority to Korean Patent Application No. 10-2023-0166507, filed on Nov. 27, 2023, the entire contents of which is incorporated herein for all purposes by this reference.

### BACKGROUND OF THE INVENTION

### Field of the Invention

The present disclosure relates to a low frequency acoustic projector, and more specifically, to a multi-resonance flextensional low frequency acoustic projector applied with a plurality of staves configured in different shapes from each other to generate two or more resonance vibration modes different from each other that is capable of transmitting the low frequency sound in a broad frequency band, and is resistant to changes in characteristics under hydrostatic pressure.

### Description of the Related Art

Acoustic projectors are used in various fields for underwater sonar detection, seafloor exploration and communication, and the like. In particular, for long-distance target detection and communication, it is important to use acoustic waves of a low frequency band having low attenuation effects.

When designing a low frequency acoustic projector for this purpose, securing broadband frequency transmission characteristics and miniaturization characteristics is the major design goal from the aspect of utilization.

A low frequency acoustic projector generally generates strong acoustic waves at a driving frequency band into a medium, using mechanical resonance of the projector. In general, an acoustic projector of a mechanical resonance type may generate a high-power acoustic pressure wave only in the vicinity of the corresponding resonance frequency. Such projector requires a size similar to a wavelength of the generated acoustic wave. Therefore, it is difficult to obtain broadband transmission characteristics and miniaturization for low-frequency projectors.

A flextensional transducer or projector, which is one of low frequency acoustic projectors, generates acoustic waves by converting longitudinal vibration of a piezoelectric actuator including a piezoelectric element into lateral vibration of a radiating plate. Since lateral vibration utilizes a bending mode of the radiating plate, rigidity of the radiating plate may be relatively lowered, and thus low-frequency operation of the projector is possible with a small size.

The type of such the flextensional projectors may be classified according to the shape and arrangement of the radiating plate and applied in response to the purpose.

However, as existing flextensional projectors use a single resonance vibration mode of the stave, there is a limitation in that the flextensional projectors may be operated only in a narrow frequency band. Furthermore, since the radiating plate requires an air-backing for effective radiation, there is a problem in that changes in acoustic characteristics occur due to the change in hydrostatic pressure according to water depth.

### SUMMARY OF THE INVENTION

An object of the present disclosure is to provide a multi-resonance flextensional low frequency acoustic projector applied with a stave having two or more resonance vibration modes different from each other by improving an existing low frequency flextensional projector driven in a single resonance vibration mode and thus having a narrow frequency bandwidth.

To accomplish the above object, according to an embodiment of the present disclosure, there may be provided a multi-resonance flextensional low frequency acoustic projector comprising: a piezoelectric actuator generates longitudinal vibration; a plurality of staves attached to an outer surface of the piezoelectric actuator to convert longitudinal vibration generated by the piezoelectric actuator into lateral vibration perpendicular to the outer surface of the piezoelectric actuator; and an acoustic window surrounding an exterior of the plurality of staves and water-tightening an inside of the projector, wherein the plurality of staves is configured in different shapes from each other to generate resonance vibration modes of two or more types.

The piezoelectric actuator may include: a piezoelectric stack in which piezoelectric elements are stacked to generate vibration in a longitudinal direction by an input electric signal; and a pair of flange that surface-contacts both end portions of the piezoelectric stack.

The plurality of staves of the present disclosure may be formed in a curved shape in a longitudinal direction thereof.

The plurality of staves of the present disclosure may be configured in different plate shapes (length, width, curvature, profile of curve) each having a different resonance frequency from each other.

The plurality of staves of the present disclosure may include a convex stave and a concave stave to have different resonance frequencies from each other.

The acoustic window of the present disclosure may have an inner shape corresponding to an outer shape of the stave.

The plurality of staves of the present disclosure may be in the form of a plate of the same shape and arranged to face each other along a circumference of the piezoelectric actuator.

The piezoelectric stack of the present disclosure may be configured by stacking piezoelectric elements of a circular disc, square plate, or polyhedral ring plate.

The flange of the present disclosure may be formed in a circular, square, or polyhedral ring structure for attachment of the staves.

The piezoelectric actuator of the present disclosure may further include an insulating plate that surface-contacts the flange and is interposed between the piezoelectric stack and the flange.

Thicknesses of the plurality of staves of the present disclosure may be different from each other to have different resonance frequencies from each other.

Curvatures of the plurality of staves of the present disclosure may be different from each other to have different resonance frequencies from each other.

A multi-resonance flextensional low frequency acoustic projector for generating acoustic waves by converting vibration of a piezoelectric element according to another embodiment (second embodiment) may comprise: a piezoelectric actuator; a plurality of staves attached to an outer surface of the piezoelectric actuator to convert longitudinal vibration generated by the piezoelectric actuator into lateral vibration perpendicular to the outer surface of the piezoelectric actuator; and an acoustic window surrounding an exterior of the plurality of staves and water-tightening the inside of the projector, wherein the plurality of staves is configured of a convex stave and a concave stave to have different resonance frequencies from each other and generates resonance vibration modes of two or more types.

The piezoelectric actuator may include: a piezoelectric stack in which piezoelectric elements are stacked to generate vibration in a longitudinal direction by an input electric signal; and a pair of flange that surface-contacts both end portions of the piezoelectric stack.

The convex stave and the concave stave may be arranged to face each other along a circumference of the piezoelectric actuator.

Thicknesses of the convex stave and the concave stave may be different from each other to have different resonance frequencies from each other.

Curvatures of the convex stave and the concave stave may be different from each other to have different resonance frequencies from each other.

A multi-resonance flextensional low frequency acoustic projector for generating acoustic waves by converting vibration of a piezoelectric element according to still another embodiment (third embodiment) may comprise: a piezoelectric actuator; a plurality of staves attached to an outer surface of the piezoelectric actuator to convert longitudinal vibration generated by the piezoelectric actuator into lateral vibration perpendicular to the outer surface of the piezoelectric actuator; an acoustic window surrounding an exterior of the plurality of staves and water-tightening the inside of the projector; and an inner space filled with air between the plurality of staves and the piezoelectric actuator, wherein the piezoelectric actuator includes: a piezoelectric stack in which piezoelectric elements are stacked to generate vibration in a longitudinal direction by an input electric signal; and a pair of flange that surface-contacts both end portions of the piezoelectric stack, wherein the plurality of staves is configured of a convex stave and a concave stave to have different resonance frequencies from each other and generates resonance vibration modes of two or more types.

The flange may be formed in a circular, square, or polyhedral ring structure for attachment of the staves.

The piezoelectric actuator further may include an insulating plate that surface-contacts the flange and is interposed between the piezoelectric stack and the flange.

### BRIEF DESCRIPTION OF THE DRAWINGS

FIG. 1(a) is a perspective view showing a multi-resonance flextensional low frequency acoustic projector according to an embodiment of the present disclosure, and FIG. 1(b) is an exemplary view showing inside of the piezoelectric actuator in FIG. 1(a).

FIGS. 2(a) and 2(b) are cross-sectional views showing a multi-resonance flextensional low frequency acoustic projector according to the present disclosure, in which FIG. 2(a) is a cross-sectional view showing a convex stave taken along line I-I in FIG. 1(a), and FIG. 2(b) is a cross-sectional view showing a concave stave taken along line II-II in FIG. 1(a).

FIG. 3 is an exemplary view showing a piezoelectric actuator of a multi-resonance flextensional low frequency acoustic projector according to the present disclosure.

FIG. 4 is an exemplary view showing a stave combined in a multi-resonance flextensional low frequency acoustic projector according to the present disclosure.

FIGS. 5(a) and 5(b) are exemplary views showing a convex stave and a concave stave of a multi-resonance flextensional low frequency acoustic projector according to the present disclosure.

FIG. 6 is a graph showing the transmission voltage response of a multi-resonance flextensional low frequency acoustic projector according to the present disclosure.

### DETAILED DESCRIPTION OF THE INVENTION

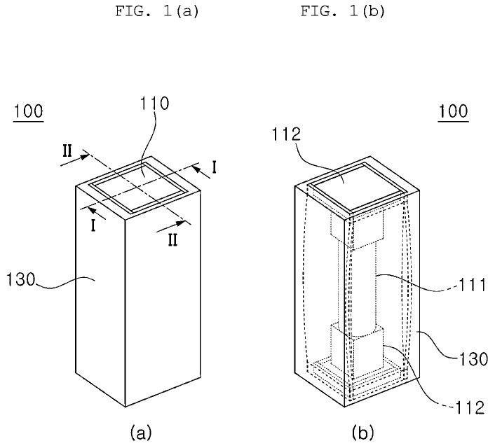

Hereinafter, in order to fully understand the present disclosure, preferred embodiments of the present disclosure will be described with reference to the accompanying drawings FIGS. 1 to 6. Embodiments of the present disclosure may be modified in various forms, and the scope of the present disclosure should not be construed as being limited to the embodiments described below in detail. It should be noted that the same configuration may be indicated by the same reference numeral in each drawing. Detailed descriptions of well-known functions and configurations determined to unnecessarily obscure the gist of the present disclosure are omitted.

A multi-resonance flextensional low frequency acoustic transducer or projector 100 (hereinafter, referred to as “projector”) according to an embodiment of the present disclosure may include a piezoelectric actuator 110 for generating vibration by an input electrical signal, a stave 120 of which both end portions are coupled to a flange 112 of the piezoelectric actuator 110 to generate acoustic waves by converting longitudinal vibration of the piezoelectric actuator 110 into lateral vibration perpendicular to a longitudinal direction of the piezoelectric actuator 110, an acoustic window 130 surrounding an exterior of the stave 120 to water-tighten an inside of the projector 100, and an inner space 140 between the stave 120 and the piezoelectric actuator 110 filled with air.

The piezoelectric actuator 110 may generate vibration in the longitudinal direction of the projector 100 from the input electrical signal.

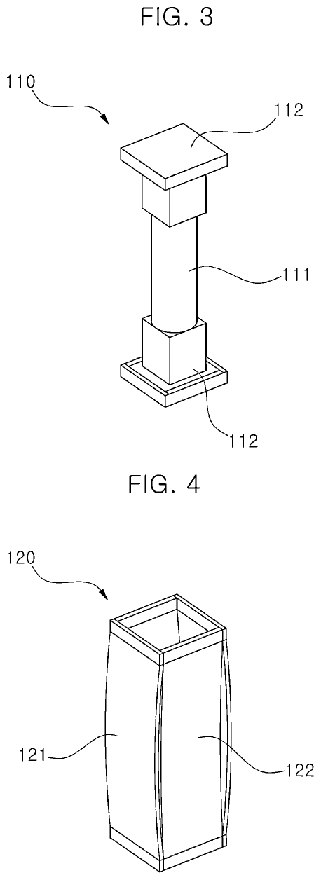

As shown in FIG. 3, an embodiment of the piezoelectric actuator 110 may be configured of a piezoelectric stack 111 that converts an electric signal into a vibration signal, and a pair of flange 112 coupled to both sides of the piezoelectric stack 111.

The piezoelectric stack 111 may have a stacked structure with piezoelectric elements 111a in a circular, square, or polyhedral ring structure. An electrode plate may be inserted or an electrode surface may be deposited between the respective piezoelectric elements 111a to apply an electric signal thereto.

The piezoelectric element may include a material capable of converting an electrical signal into a mechanical signal, for example, at least one material among PZT [Pb(Zr/Ti)O3], PMN-PT[Pb(Mg2/3Nb1/3)O3-PbTiO3], PIN-PMN-PT[Pb(In1/2Nb1/2)O3-Pb(Mg2/3Nb1/3)O3-PbTiO3], PIN-PMN-PT Mn doped, and PMN-PZT[Pb(Mg2/3Nb1/3)O3-PbZrO3-PbTiO3].

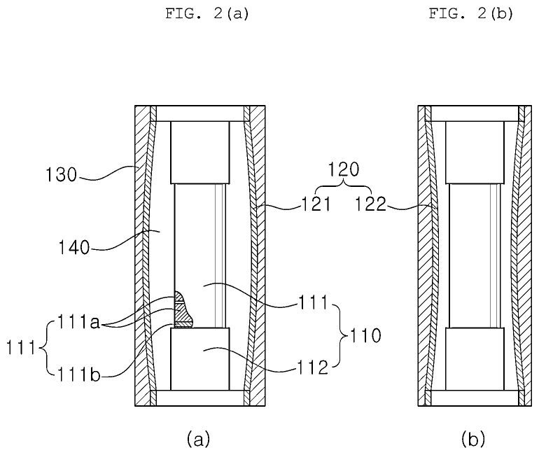

In addition, referring to FIG. 2, the piezoelectric stack 111 may have insulating plates 111b at both end portions to insulate electrical high-voltages, which are applied to electrodes (not shown), from the structure.

The insulating plates 111b may be configured to surface-contact the flange 112, and may be applied in a ring-shaped structure which is the same as that of the piezoelectric stack 111.

The insulating plate 111b may be made by applying an insulating material such as alumina, glass fiber reinforced plastic (GRP), ceramic, glass, engineering plastic, or the like.

The flange 112 may be in surface-contact with both end portions of the piezoelectric stack 111, respectively, and fixed by attaching the stave 120 to the side surfaces of the flange 112.

The shape of the flange 112 may be a circular, square, or polyhedral ring structure for attachment of the stave 120, and the thickness and diameter of the flange 112 may be determined considering vibration characteristics of the stave 120.

Iron, aluminum, tungsten, brass, engineering plastic, or the like may be applied as the material of the flange 112.

The flange 112 may be fixed while being attached to the piezoelectric stack 111, and a tension bolt (not shown) may be applied to allow high-output driving of the piezoelectric elements 111a which are vulnerable to tension by applying a compressive pre-stress to the piezoelectric elements 111a of the piezoelectric stack 112.

A strong metal material such as iron, aluminum, tungsten, or the like may be applied to make the tension bolt.

Meanwhile, both ends of the stave 120 may be fixed to the flange 112 of the piezoelectric actuator 110, and a plurality of the staves 120 may be arranged along the piezoelectric actuator 110 and vibrate in an independent flextentional mode.

Each stave 120 may be configured to have two or more resonance frequencies different from each other according to by the length, width, bending curvature, and bending profile thereof. The projector 100 may be implemented to allow low frequency acoustic transmission in a wide frequency band by configuring two or more resonance frequencies to be adjacent to each other.

The stave 120 may be arranged in plural in a circumferential direction of the piezoelectric actuator 110 to surface-contact the flange 112. Here, a plurality of staves 120 may be configured in different plate shapes.

In other words, the plurality of staves 120 may be configured in different shapes (length, width, curvature, profile of curve) each having a different frequency from each other. For the wide frequency characteristics of the acoustic projector, resonance vibration modes of two or more types may be configured to be adjacent to each other.

Iron, aluminum, tungsten, brass, engineering plastic, or the like may be applied as the material of the stave 120.

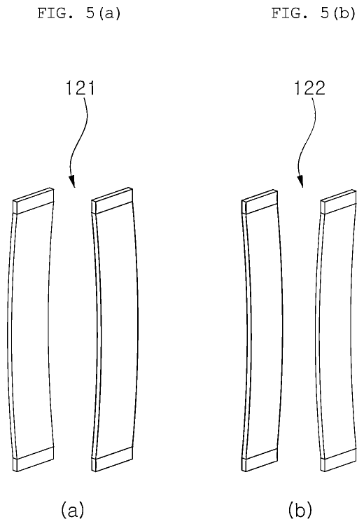

Meanwhile, the stave 120 of a dual resonance acoustic projector applied to an embodiment of the multi-resonance flextensional low frequency acoustic projector 100 may have two resonance frequencies different from each other, as shown in FIGS. 4 and 5.

The stave 120 may be in the form of a plate of a convex stave 121 shown in FIG. 5(a) and a concave stave 122 shown in FIG. 5(b), and may be arranged to surface-contact the side surfaces of the flange 112 of the piezoelectric actuator 110 so that the staves 121 and 122 of the same shape face each other.

Both end portions of the stave 120 may be fixed to the flange 112 and radiate acoustic waves by converting the longitudinal vibration of the piezoelectric actuator 110 into lateral vibration.

When the stave 120 has both shapes of the convex stave 121 and the concave stave 122, the convex stave 121 generates a tensile force while the concave stave 122 generates a compressive force under the hydrostatic pressure. Therefore, the force generated from the stave 120 is offset each other, and there is an effect of reducing the stress applied to the piezoelectric actuator 110 under the hydrostatic pressure.

The resonance frequency of the stave 120 may be determined by the length, width, bending curvature, and bending profile of a plate constituting the stave 120.

The acoustic window 130 may be shaped to surround the exterior of the stave 120 to fit the shape of the stave 120 and functions to watertight the inside of the projector 100.

In addition, a polymer material such as rubber, urethane, or the like may be applied as the material of the acoustic window 130 to have acoustically transparent characteristics.

The longitudinal vibration generated in the piezoelectric actuator 110 may be transmitted to the stave 120 attached to the piezoelectric actuator 110 and converted into the lateral vibration to generate acoustic waves.

The stave 120 may be attached to the side surfaces of the piezoelectric actuator 110 and have omnidirectional characteristics of emitting acoustic waves in all directions without directivity.

That is, the stave 120 may include the convex stave 121 and the concave stave 122 and may be driven in an independent resonance vibration mode.

At this point, the resonance vibration modes of the convex stave 121 and the concave stave 122 may be configured by the thickness, length, and curvature of the plates constituting the convex stave 121 and the concave stave 122, and when the two resonance vibration modes are configured to be adjacent to each other, broadband transmission is possible.

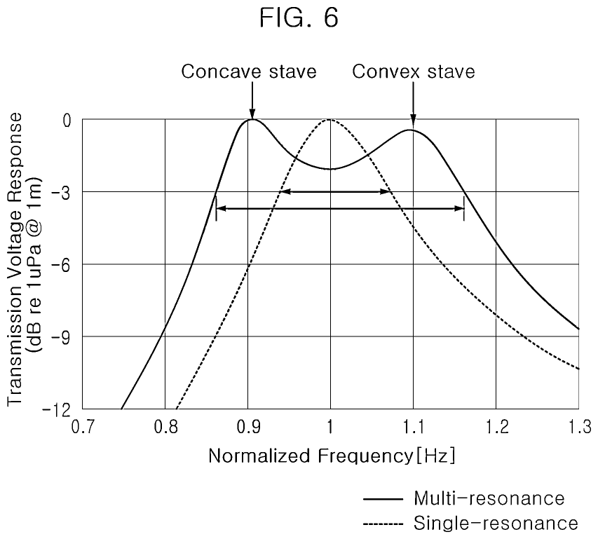

The normalized frequency characteristics of a transmitting voltage response of the flextensional low frequency projector is shown in FIG. 6. Referring to FIG. 6, a multi-resonance flextensional projector utilizing both the convex stave 121 and the concave stave 122 shows two resonance peak in its frequency response as illustrated in a solid line. On the other side, a single-resonance flextensional projector utilizing only the concave stave 122 shows only single resonance peak in its frequency response as illustrated in a dotted line. It would be noted that the multi-resonance projector according to the present disclosure shows a broader frequency bandwidth compared with the conventional single-resonance projectors.

As described above, in the multi-resonance flextensional low frequency acoustic projector of the present disclosure, as a plurality of staves having two or more resonance frequencies different from each other is installed to be adjacent to each other and driven in an independent resonance vibration mode, there is an effect of allowing low frequency acoustic transmission in a wide frequency band.

In addition, as the stress applied to the piezoelectric actuator is reduced as the deformations of the plate constituting the stave generated when hydrostatic pressure is applied are offset each other by applying both a convex stave and a concave stave, there is an effect of reducing changes in acoustic characteristics that occur due to the change in hydrostatic pressure according to water depth.

Meanwhile, the present disclosure is not limited to the embodiments described above, and may be implemented by changing and modifying within the scope that does not depart from the gist of the present invention, and the technical spirit to which such changes and modifications are applied should also be regarded as falling within the scope of the patent claims described below.

What is claimed is:

1. A multi-resonance flextensional low frequency acoustic projector for generating acoustic waves by converting vibration of a piezoelectric element, the projector comprising:
a piezoelectric actuator 110;
a plurality of staves 120 attached to an outer surface of the piezoelectric actuator 110 to convert longitudinal vibration generated by the piezoelectric actuator 110 into lateral vibration perpendicular to the outer surface of the piezoelectric actuator 110; and
an acoustic window 130 surrounding an exterior of the plurality of staves 120 and water-tightening an inside of the projector 100,
wherein the plurality of staves 120 is configured in different shapes from each other to generate two or more types of resonance vibration modes.

2. The multi-resonance flextensional low frequency acoustic projector according to claim 1, wherein the piezoelectric actuator 110 includes:
a piezoelectric stack 111 in which piezoelectric elements 111a are stacked to generate vibration in a longitudinal direction by an input electric signal; and
a pair of flange 112 surface-contacting both end portions of the piezoelectric stack 111.

3. The multi-resonance flextensional low frequency acoustic projector according to claim 1, wherein the plurality of staves 120 is formed in a curved shape in a longitudinal direction thereof.

4. The multi-resonance flextensional low frequency acoustic projector according to claim 3, wherein the plurality of staves 120 is configured in different plate shapes each having a different resonance frequency from each other.

5. The multi-resonance flextensional low frequency acoustic projector according to claim 4, wherein the plurality of staves 120 includes a convex stave 121 and a concave stave 122 to have different resonance frequencies from each other.

6. The multi-resonance flextensional low frequency acoustic projector according to claim 1, wherein the acoustic window 130 has an inner shape corresponding to an outer shape of the stave 120.

7. The multi-resonance flextensional low frequency acoustic projector according to claim 1, wherein the plurality of staves 120 is in the form of a plate of the same shape and arranged to face each other along a circumference of the piezoelectric actuator 110.

8. The multi-resonance flextensional low frequency acoustic projector according to claim 2, wherein the piezoelectric stack 111 is configured by stacking piezoelectric elements 111a of a circular disc, square plate, or polyhedral ring plate.

9. The multi-resonance flextensional low frequency acoustic projector according to claim 2, wherein the flange 112 are in a circular disc, square plate, or polyhedral ring plate for attachment of the staves 120.

10. The multi-resonance flextensional low frequency acoustic projector according to claim 2, wherein the piezoelectric actuator 110 further includes an insulating plate 111b that surface-contacts the flange 112 and is interposed between the piezoelectric stack 111 and the flange 112.

11. The multi-resonance flextensional low frequency acoustic projector according to claim 4, wherein thicknesses of the plurality of staves 120 are different from each other to have different resonance frequencies from each other.

12. The multi-resonance flextensional low frequency acoustic projector according to claim 4, wherein curvatures of the plurality of staves 120 are different from each other to have different resonance frequencies from each other.

13. A multi-resonance flextensional low frequency acoustic projector for generating acoustic waves by converting vibration of a piezoelectric element, the projector comprising:
a piezoelectric actuator 110;
a plurality of staves 120 attached to an outer surface of the piezoelectric actuator 110 to convert longitudinal vibration generated by the piezoelectric actuator 110 into lateral vibration perpendicular to the outer surface of the piezoelectric actuator 110; and
an acoustic window 130 surrounding an exterior of the plurality of staves 120 and water-tightening the inside of the projector 100, wherein
the plurality of staves 120 is configured of a convex stave 121 and a concave stave 122 to have different resonance frequencies from each other to generate two or more types of resonance vibration modes.

14. The multi-resonance flextensional low frequency acoustic projector according to claim 13, wherein the piezoelectric actuator 110 includes:
a piezoelectric stack 111 in which piezoelectric elements are stacked to generate vibration in a longitudinal direction by an input electric signal; and
a pair of flange 112 that surface-contacts both end portions of the piezoelectric stack 111.

15. The multi-resonance flextensional low frequency acoustic projector according to claim 14, wherein the convex stave 121 and the concave stave 122 are arranged to face each other along a circumference of the piezoelectric actuator 110.

16. The multi-resonance flextensional low frequency acoustic projector according to claim 14, wherein thicknesses of the convex stave 121 and the concave stave 122 are different from each other to have different resonance frequencies from each other.

17. The multi-resonance flextensional low frequency acoustic projector according to claim 14, wherein curvatures of the convex stave 121 and the concave stave 122 are different from each other to have different resonance frequencies from each other.

18. A multi-resonance flextensional low frequency acoustic projector for generating acoustic waves by converting vibration of a piezoelectric element, the projector comprising:
a piezoelectric actuator 110;
a plurality of staves 120 attached to an outer surface of the piezoelectric actuator 110 to convert longitudinal vibration generated by the piezoelectric actuator 110 into lateral vibration perpendicular to the outer surface of the piezoelectric actuator 110;
an acoustic window 130 surrounding an exterior of the plurality of staves 120 and water-tightening the inside of the projector 100; and
an inner space 140 filled with air between the plurality of staves 120 and the piezoelectric actuator 110,
wherein the piezoelectric actuator 110 includes:
a piezoelectric stack 111 in which piezoelectric elements 111a are stacked to generate vibration in a longitudinal direction by an input electric signal; and
a pair of flange 112 that surface-contacts both end portions of the piezoelectric stack 111,
wherein the plurality of staves 120 is configured of a convex stave 121 and a concave stave 122 to have different resonance frequencies from each other to generate two or more types of resonance vibration modes.

19. The multi-resonance flextensional low frequency acoustic projector according to claim 18, wherein the flange 112 are in a circular, square, or polyhedral ring structure for attachment of the staves 120.

20. The multi-resonance flextensional low frequency acoustic projector according to claim 19, wherein the piezoelectric actuator 110 further includes an insulating plate 111b that surface-contacts the flange 112 and is interposed between the piezoelectric stack 111 and the flange 112.
